(19) United States
(12) Patent Application Publication
(10) Pub. No.: US 2018/0084758 A1
(43) Pub. Date: Mar. 29, 2018

(54) Adjustable Telescopic Cat Scratching Post

(71) Applicant: Mingwu Zhu, Shanghai (CN)

(72) Inventor: Mingwu Zhu, Shanghai (CN)

(21) Appl. No.: 15/590,840

(22) Filed: May 9, 2017

(30) Foreign Application Priority Data
May 10, 2016 (CN) 201620418863. 5

(51) Int. Cl. A01K 15/02

(52) U.S. Cl. CPC A01K 15/024

(57) ABSTRACT

The present utility model discloses an adjustable telescopic cat scratching post, comprising a cylinder and a regulating base. Scratch patterns are disposed on the outer side surface of the cylinder, and a threaded regulating port is upwardly disposed inside the cylinder. A thread section matching the regulating port is arranged at the upper end of the regulating base. The thread section is screwed into the regulating port and regulates the overall height of the cat scratching post by regulating the height of the part of the thread section screwed into the regulating port. The cat scratching post in the present application is adjustable and telescopic and intended to be fixed between a table and the floor, or between two other objects. This design not only plays a role in fixing the toy but also may prevent loss, save space and make for assembly and regulation.

### RELATED APPLICATION

This application is a U.S. filing of the Chinese Patent Application ZL 2016 2 0418863.5, filed on 10 May 2016, with an authorization date of 9 Nov. 2016, the disclosure of which is hereby incorporated herein by reference in its entirety.

### TECHNICAL FIELD

The present utility model relates to the field of pet toys, more specifically, to an adjustable telescopic cat scratching post suitable for play by cats.

### BACKGROUND

Pets are typically treated as members of families and show increasing involvement in owner's lives and bring endless joy to pet owners. The consumer goods of pets also create infinite opportunities for merchants. In order that pets can enjoy the fun while bringing joy to pet owners, pet toys emerged. However, the existing cat toys almost all are unfixed and might be lost by cats.

### SUMMARY

The present utility model provides an adjustable telescopic cat scratching post, which can effectively solve the foregoing problem in the prior art.

The present utility model solves the foregoing problem by using the following technical scheme:

An adjustable telescopic cat scratching post, comprising a cylinder and a regulating base, wherein scratch patterns are disposed on the outer side surface of the cylinder, and a threaded regulating port is upwardly disposed inside the cylinder; a thread section matching the regulating port is arranged at the upper end of the regulating base; the thread section is screwed into the regulating port and regulates the overall height of the cat scratching post by regulating the height of the part of the thread section screwed into the regulating port.

The space between the scratch patterns is same as the space between cat claws.

A sucking piece is disposed on the margin of the top surface of the cylinder.

The cat scratching post in the present application is adjustable and telescopic and intended to be fixed between a table and the floor, or between two other objects. This design not only plays a role in fixing the toy but also may prevent loss, save space and make for assembly and regulation.

### BRIEF DESCRIPTION OF THE DRAWINGS

Having thus described the invention in general terms, reference will now be made to the accompanying drawings, which are not necessarily drawn to scale, and wherein:

FIG. 1 is an exploded schematic view of an embodiment of the present utility model; and

FIG. 2 is a schematic view of the present utility model in a use state.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

Below the present utility model will be illustrated by referring to embodiments.

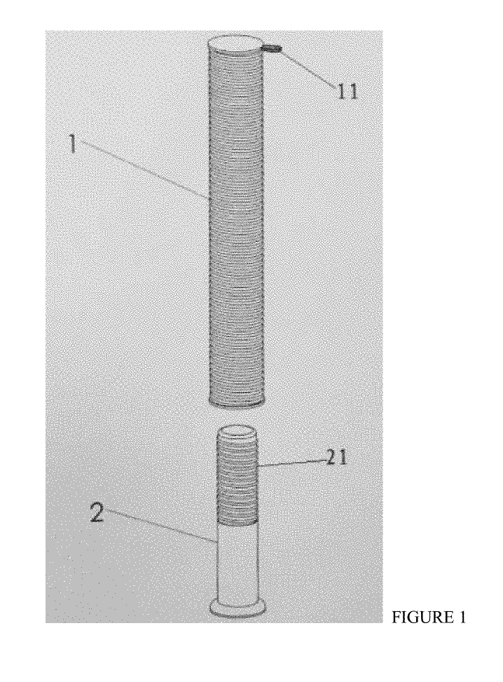

As shown in FIG. 1, the adjustable telescopic cat scratching post in the present application comprises a cylinder 1 and a regulating base 2. Scratch patterns are disposed on the outer side surface of the cylinder 1, and the space between the scratch patterns is same as the space between cat claws. A threaded regulating port is upwardly disposed inside the cylinder 1. A thread section 21 matching the regulating port is arranged at the upper end of the regulating base 2. The thread section is screwed into the regulating port and regulates the overall height of the cat scratching post by regulating the height of the part of the thread section screwed into the regulating port.

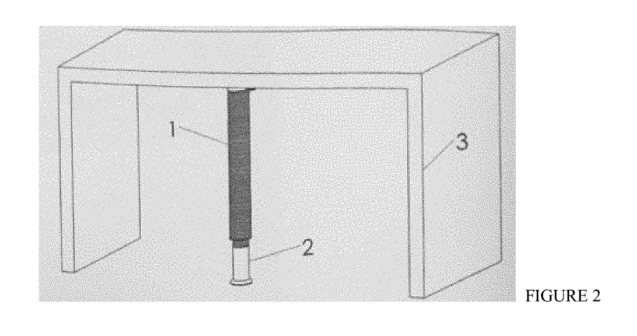

FIG. 2 is a schematic view of the present utility model in a use state. The adjustable telescopic cat scratching post is fixed between the bottom surface of a table 3 and the floor. This design not only makes for play of the cat but also can save space. Further, a cat toy with a relatively fixed size makes for packaging.

Further, as an alternative preferred embodiment, a sucking piece 11 is disposed on the margin of the top surface of the cylinder 1. The sucking piece 11 helps suck the cylinder onto the bottom surface of the table and plays a desirable fixing role.

It should be understood that these embodiments are intended to illustrate and not to limit the present utility model; after reading the content described in the present utility model, those skilled in the art may make various changes or modifications to the present utility model, and all these changes and modifications shall be within the scope limited by the claims of the present application.

The scratch patterns may comprise a sisal material or rope.

The sucking piece may comprise a piece of friction material (such as felt) to prevent dislodging of the cylinder from underneath the table. The sucking piece may comprise at least one fastener such as a removable adhesive or Velcro (loop and hook fastener). The sucking piece may also comprise a suction cup.

The table may be a table, a dining table, a kitchen table, a counter top, a desk, a low table (such as a coffee table), a high table (such as a bar, breakfast bar). The table may rest upon a floor of a room of a building. The table may rest upon the ground (dirt, grass, stones, cement, etc.) of the outside.

The embodiments of the apparatus can be made from numerous materials including different types of woods, plastics (e.g. ABS plastic), metals (e.g. aluminum, or steel), glass, fiberglass, and carbon fiber. The embodiments may be constructed from combinations of the different materials.

The cylinder may include a toy or other object that is attached to the cylinder. The toy may be removable attached to the cylinder to allow for replacement with another toy of object.

The regulating base may be covered with a sisal material or felt.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An adjustable telescopic cat scratching post, characterized in that it comprises:
a cylinder, provided with scratch patterns on its outer side surface, and a threaded regulating port upwardly disposed inside the cylinder; and
a regulating base, provided with a thread section at its upper end, which matches the regulating port, is screwed into the regulating port and regulates the overall height of the cat scratching post by regulating the height of the part of the thread section screwed into the regulating port.

2. The adjustable telescopic cat scratching post according to claim 1, characterized in that the space between the scratch patterns is same as the space between cat claws.

3. The adjustable telescopic cat scratching post according to claim 1, characterized in that a sucking piece is disposed on the margin of top surface of the cylinder.
